(19) United States
(12) Patent Application Publication
(10) Pub. No.: US 2022/0325930 A1
(43) Pub. Date: Oct. 13, 2022

(54) BATTERY-INTEGRATED HEAT PUMP SYSTEMS AND METHODS OF MANAGING BATTERY TEMPERATURES

(71) Applicant: Rheem Manufacturing Company, Atlanta, GA (US)

(72) Inventors: Christopher Day, Colleyville, TX (US); Sivakumar Gopalnarayanan, Plano, TX (US); Yang Zou, Frisco, TX (US)

(21) Appl. No.: 17/224,218

(22) Filed: Apr. 7, 2021

(51) Int. Cl. F25B 49/02; F25B 13/00; F25B 30/02

(52) U.S. Cl. CPC F25B 49/02; F25B 13/00; F25B 30/02; F25B 2700/15

(57) ABSTRACT

The disclosed technology includes devices, systems, and methods for a battery-integrated heat pump system. The disclosed technology can include a heat pump system having an indoor heat exchanger coil, an outdoor heat exchanger coil, and a compressor. The disclosed technology can further include a third heat exchanger coil, a battery, and a pump configured to circulate a fluid through the third heat exchanger coil and the battery. The disclosed technology can be configured to manage the temperature of the battery by operating the pump to facilitate heat transfer between the refrigerant and the fluid to heat or cool the battery.

### FIELD OF TECHNOLOGY

The disclosed technology relates generally to heat pump systems and/or home battery systems, more particularly, to battery-integrated heat pump systems.

### BACKGROUND

Heat pump systems that utilize batteries to power various components of the heat pump system are often limited in their implementation because the temperature of the battery must be kept within a specific temperature range. If the battery is operated or stored outside of the specific temperature range, the performance of the battery can be negatively impacted, the battery can be damaged, and/or the battery can eventually be incapable of maintaining a charge. For example, if the battery is allowed to reach a prohibitively high temperature during operation or even during storage, the battery can become damaged. Similarly, if the temperature of the battery falls below a low temperature threshold, the battery can become unable to maintain a charge. Because of these temperature limitations of the battery, many battery-integrated heat pump systems are unable to be deployed in locations where high or low ambient temperatures are common. Although battery temperature management systems exist, many of these systems require a separate power source or draw power directly from the battery which can lead to reduced performance of the battery.

What is needed, therefore, is a device and system capable of maintaining the temperature of the batteries within an optimal operating temperature range while increasing the total efficiency of the battery-integrated heat pump system.

These and other problems are addressed by the technology disclosed herein.

### SUMMARY

The disclosed technology relates generally to heat pump systems and, more particularly, to battery-integrated heat pump systems. The disclosed technology can include a system having an indoor heat exchanger coil and an outdoor heat exchanger coil in fluid communication with a refrigerant circuit. The system can include a compressor in fluid communication with the refrigerant circuit that can be configured to circulate a refrigerant through the refrigerant circuit. The system can include a battery and a pump that can each be in thermal communication with a fluid circuit. The pump can be configured to circulate a fluid through the fluid circuit. A third heat exchanger coil can be in fluid communication with the refrigerant circuit and the fluid circuit and be configured to facilitate heat transfer between the refrigerant and the battery via the fluid.

The fluid can be water and the system can include a water heater that can be in fluid communication with the fluid circuit and configured to heat the water to facilitate heating of the battery. The system can include a thermal energy storage system that can be in fluid communication with the fluid circuit that is configured to store thermal energy transferred to the thermal energy storage system by the fluid and transfer the stored thermal energy to the fluid to facilitate heating and cooling of the battery. The system can include one or more valves that can be configured to control a first flow of the refrigerant through the outdoor heat exchanger coil and a second flow of the refrigerant through the third heat exchanger coil.

The system can include a condensate pump that can be in fluid communication with the fluid circuit. The condensate pump can be configured to move condensate from the indoor heat exchanger coil to the battery to facilitate cooling of the battery. The system can include a fourth heat exchanger that can be in fluid communication with the fluid circuit and facilitate heat transfer between the fluid and air.

The system can include a battery temperature sensor that can be configured to detect a temperature of the battery. The system can include a controller that is configured to receive battery temperature data from the battery temperature sensor output a control signal to the pump to circulate the fluid through the fluid circuit based at least in part on the battery temperature data.

The system can include a valve that is configured to control a flow of the refrigerant through the third heat exchanger. The controller can be configured to output a control signal to the valve to change a position of the valve to control the flow of the refrigerant through the third heat exchanger based at least in part on the battery temperature data.

The controller can be further configured to output a control signal to the water heater to activate the water heater and begin heating the water based at least in part on the battery temperature data indicating that the battery temperature is less than a low temperature threshold.

The controller can be further configured to output a control signal to the condensate pump to move condensate from the indoor heat exchanger coil to the battery to facilitate cooling of the battery based at least in part on the battery temperature data indicating that the battery temperature is greater than or equal to a high temperature threshold.

The system can include a fourth heat exchanger that can be in fluid communication with the fluid circuit and configured to facilitate heat transfer between the fluid and air. The system can include a valve configured to control a flow of the refrigerant through the third heat exchanger. The controller can be configured to output a control signal to the valve to change a position of the valve to control the flow of the refrigerant through the third heat exchanger based at least in part on the battery temperature data.

The disclosed technology can include a non-transitory, computer-readable medium storing instructions that, when executed by one or more processors, cause a controller associated with a heat pump system to receive battery temperature data from a battery temperature sensor. The battery temperature data can be indicative of a battery temperature measured by the battery temperature sensor. The instructions can cause the controller to receive ambient air temperature data from an ambient air temperature sensor. The ambient air temperature data can be indicative of an ambient air temperature measured by the ambient air temperature sensor.

In response to determining that (i) the battery temperature is greater than a battery low temperature threshold and (ii) the ambient air temperature is greater than an ambient air low temperature threshold, the controller can output a control signal to a control valve to cause refrigerant to flow in a first direction through an auxiliary heat exchanger in thermal communication with the battery to thereby effect a first heat transfer of waste heat from the battery to a fluid and a second heat transfer from the fluid to the refrigerant via the auxiliary heat exchanger.

In response to determining that the battery temperature is less than or equal to the battery low temperature threshold, the controller can output a control signal to the control valve to cause the refrigerant to flow in a second direction through the auxiliary heat exchanger to thereby effect a third heat transfer from the refrigerant to the fluid via the auxiliary heat exchanger and a fourth heat transfer from the fluid to the battery. The second direction can be substantially opposite from the first direction.

The fluid can be water and, in response to determining that the battery temperature is less than or equal to the battery low temperature threshold, the controller can output a control signal to a water heater to provide heat to the water to thereby effect a transfer of heat from the water to the battery.

In response to determining that the battery temperature is greater than or equal to a battery high temperature threshold, the controller can output a control signal to the control valve to cause the refrigerant to flow in the first direction through the auxiliary heat exchanger to thereby effect a third heat transfer from the battery to the fluid and a fourth heat transfer from the fluid to the refrigerant via the auxiliary heat exchanger to cool the battery.

Additional features, functionalities, and applications of the disclosed technology are discussed herein in more detail.

### BRIEF DESCRIPTION OF THE DRAWINGS

The accompanying drawings, which are incorporated in and constitute a part of this specification, illustrate various aspects of the presently disclosed subject matter and serve to explain the principles of the presently disclosed subject matter. The drawings are not intended to limit the scope of the presently disclosed subject matter in any manner.

FIG. 1 illustrates an existing heat pump system in cooling mode.

FIG. 2 illustrates the existing heat pump system of FIG. 1 in heating mode, in accordance with heat pump systems currently known in the art.

FIG. 3 illustrates a schematic diagram of a battery-integrated heat pump system in a cooling mode with battery temperature management, in accordance with the disclosed technology.

FIG. 4 illustrates a schematic diagram of a battery-integrated heat pump system in a heating mode with battery temperature management, in accordance with the disclosed technology.

FIG. 5 illustrates a schematic diagram of a battery-integrated heat pump system in a heating mode with battery temperature management via a water heater, in accordance with the disclosed technology.

FIG. 6 illustrates a schematic diagram of a battery-integrated heat pump system in a heating mode and utilizing waste heat generated from a battery, in accordance with the disclosed technology.

FIG. 7 illustrates a schematic diagram of a battery-integrated heat pump system in a cooling mode and configured to cool the battery with condensate from the indoor coil, in accordance with the disclosed technology.

FIG. 8 illustrates a schematic diagram of a battery-integrated heat pump system in a cooling mode and having a water-to-air heat exchanger to provide cooling to the battery, in accordance with the disclosed technology.

FIG. 9 illustrates a schematic diagram of a battery-integrated heat pump system in a cooling mode and providing cooling to the battery with an auxiliary heat exchanger, in accordance with the disclosed technology.

FIG. 10 illustrates a schematic diagram of a battery-integrated heat pump system in a heating mode and providing heating to the battery with an auxiliary heat exchanger, in accordance with the disclosed technology.

FIG. 11 illustrates a schematic diagram of a battery-integrated heat pump system in a heating mode with battery temperature management and configured to facilitate heating with a water-to-air heat exchanger, in accordance with the disclosed technology.

FIG. 12 illustrates a schematic diagram of a battery-integrated heat pump system in a heating mode and utilizing waste heat generated from a battery, in accordance with the disclosed technology.

FIG. 13 illustrates a schematic diagram of a battery-integrated heat pump system in a cooling mode and configured to cool the battery with condensate from the indoor coil, in accordance with the disclosed technology.

FIG. 14 illustrates a schematic diagram of a controller connected to various components of the battery-integrated heat pump system, in accordance with the disclosed technology.

FIG. 15 illustrates a flow chart of a method of operating the battery-integrated heat pump system, in accordance with the disclosed technology.

### DETAILED DESCRIPTION

The disclosed technology can include a heat pump system that can be powered by a battery and efficiently and effectively manage the temperature of the battery. The heat pump system can include a compressor, a condenser, and an evaporator similar to existing heat pump systems. The disclosed technology, however, can further include a pump that can circulate a fluid to the battery and an additional heat exchanger to facilitate heat transfer between the refrigerant in the heat pump system and the fluid to help control a temperature of the fluid and the battery. The additional heat exchanger can be configured to add heat to, or remove heat from, the fluid being circulated to the battery depending on a directional flow of the refrigerant through the additional heat exchanger. Accordingly, the heat pump system can help to control the temperature of the battery in an efficient and effective manner. The heat pump system can further include a water heater, a thermal energy storage system, a condensate pump, and/or an additional heat exchanger to facilitate further temperature management of the battery. Further configurations and advantages of the disclosed technology will become apparent throughout this disclosure.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of being systems and methods for use with a battery-integrated heat pump system. The present disclosure, however, is not so limited, and can be applicable in other contexts. The present disclosure can include devices and systems for use with variable speed heat pump systems, fixed speed heat pump systems, packaged heat pump systems, heat pump water heaters, air conditioning systems, refrigeration systems, and other similar systems. Accordingly, when the present disclosure is described in the context of battery-integrated heat pump systems, it will be understood that other implementations can take the place of those referred to.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open- ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” can be used herein to connote different aspects of methods employed, the term should not be interpreted as implying any particular order among or between various steps herein disclosed unless and except when the order of individual steps is explicitly required. Further, the disclosed technology does not necessarily require all steps included in the methods and processes described herein. That is, the disclosed technology includes methods that omit one or more steps expressly discussed with respect to the methods described herein.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, similar components that are developed after development of the presently disclosed subject matter.

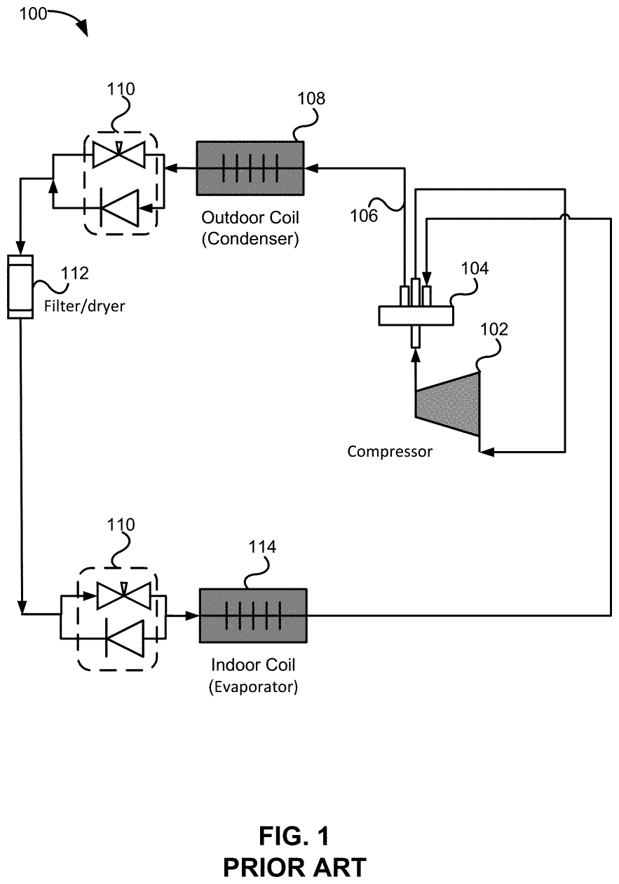

Referring now to the drawings, in which like numerals represent like elements, the present disclosure is herein described. FIG. 1 illustrates a heat pump system 100 in cooling mode, in accordance with heat pump systems currently known in the art. The heat pump system 100 can include a compressor 102, a reversing valve 104, an outdoor coil 108, an expansion and check valve assembly 110, and an indoor coil 114. The various components can be connected via refrigerant lines 106 such that a refrigerant can be circulated through the various components to operate the heat pump system 100. The heat pump system 100 can further include a filter/dryer assembly 112 to help ensure the refrigerant does not accumulate moisture or debris which could damage the various components of the heat pump system 100.

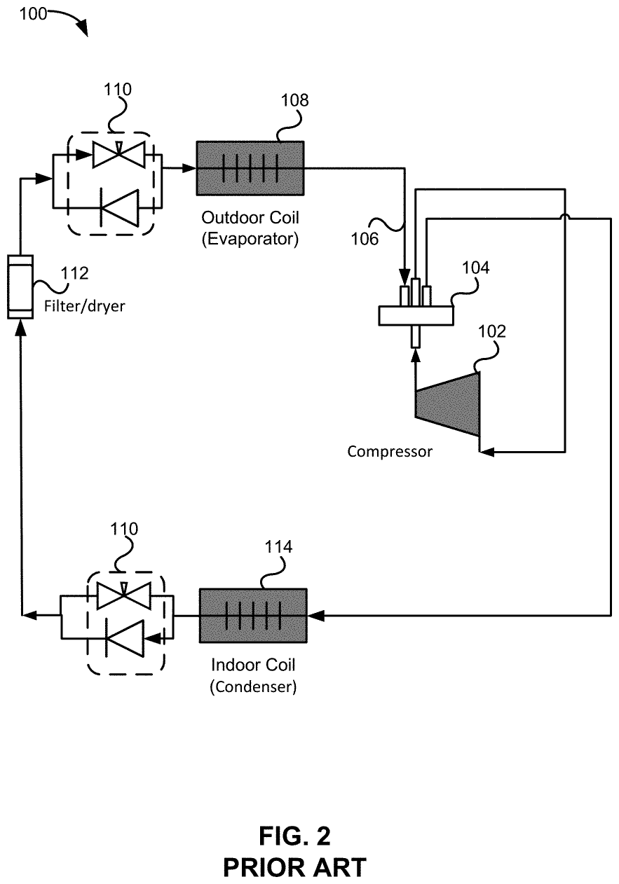

As will be appreciated by one of skill in the art, the heat pump system 100 can be configured to operate in a cooling mode to reduce a temperature of air circulated through a building to provide space cooling. Furthermore, as depicted in FIG. 2 in accordance with heat pump systems currently known in the art, the reversing valve 104 can be actuated to reverse a direction of the refrigerant flowing through the refrigerant lines 106 to cause the heat pump system 100 to increase a temperature of air circulated through the building to provide space heating. In this way, the outdoor coil 108 and the indoor coil 114 can act as either a condenser or an evaporator depending on the direction of the refrigerant flow.

The outdoor coil 108 and the indoor coil 114 can be or include any type of heat exchanger coil configured to facilitate heat transfer between the refrigerant and a fluid. The fluid, for example, can be air, water, glycol, dielectric fluids, or any other type of fluid suitable for the particular application. As will be appreciated by one of skill in the art, the indoor coil 114 can be configured to exchange heat between air circulated through the building and the refrigerant to provide either space heating or space cooling as necessary to maintain the indoor temperature of the building. Furthermore, the outdoor coil 108 can be configured to exchange heat between ambient air outside of the building.

To facilitate operation of the heat pump system 100 in either the heating mode or the cooling mode, the expansion and check valve assembly 110 can include an expansion valve and a check valve. When the refrigerant is flowing through the expansion and check valve assembly 110 in a first direction, the refrigerant can pass through the expansion valve and expand to facilitate a change from a liquid state to a vapor state of the refrigerant. When the refrigerant is flowing through the expansion and check valve assembly 110 in a second direction, the refrigerant can pass through the check valve and bypass the expansion valve.

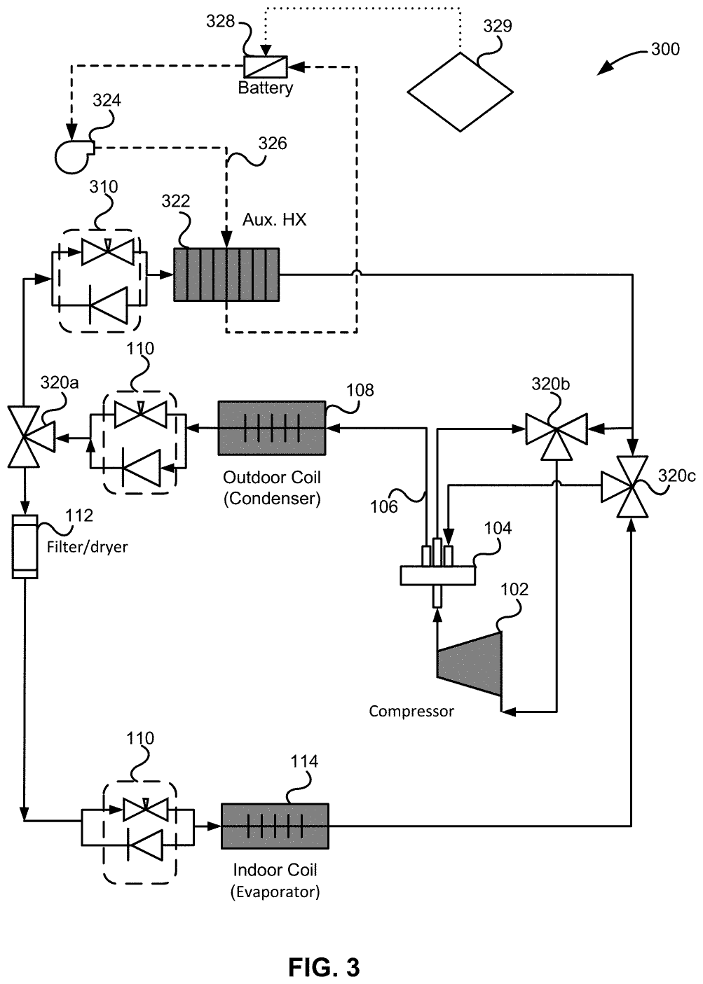

FIG. 3 illustrates a battery-integrated heat pump system 300 that can facilitate battery temperature management, in accordance with the disclosed technology. The battery-integrated heat pump system 300 can include one, some, or all of the components and/or features previously described in relation to the heat pump system 100. The battery-integrated heat pump system 300 can further include a battery 328 that can be configured to provide power to various components in the battery-integrated heat pump system 300. The battery 328, for example and not limitation, can be configured to provide power to the compressor 102 and/or the reversing valve 104 to operate the battery-integrated heat pump system 300. The battery 328 can be any type of battery capable of providing power to the various components of the battery-integrated heat pump system 300.

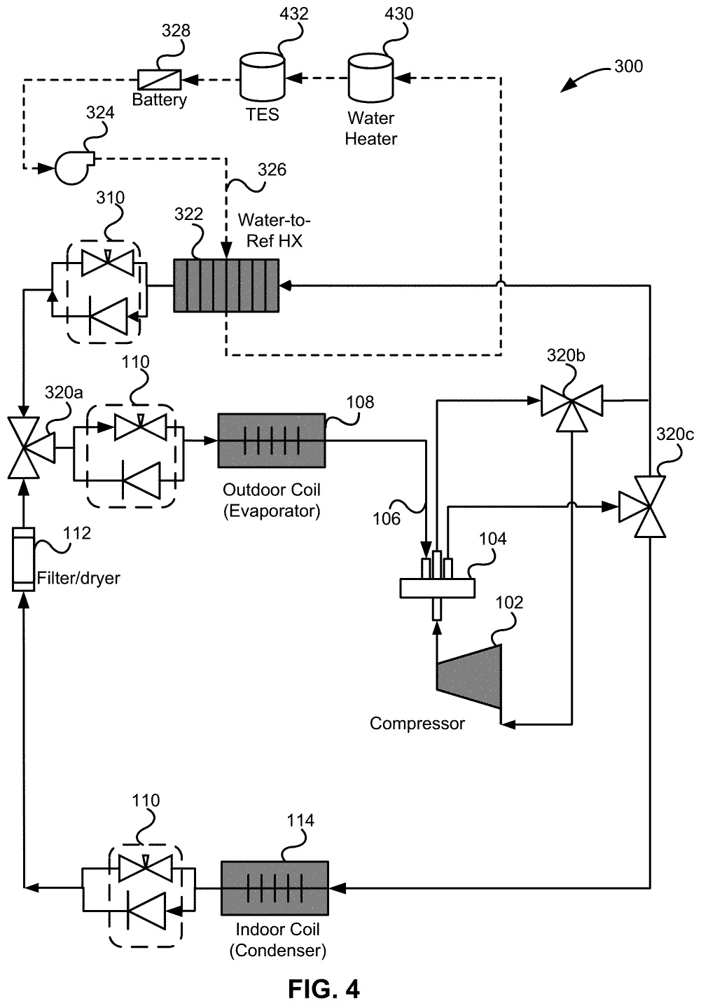

The system 300 can include a solar panel 329 (or other photovoltaic power source) to provide a charge to the battery 328. The solar panel 329 can be any type of solar panel including a monocrystalline, polycrystalline, or thin-film type solar panel. Furthermore, the solar panel 329 can be installed proximate the battery 328, or the solar panel 329 can be installed remote from the battery 328 provided the solar panel 329 is in electrical communication with the battery 328. Although illustrated as including a solar panel 329, the disclosed technology can include other DC power sources in addition to, or in place of, the solar panel 329 to charge the battery 328. The disclosed technology can include other DC power sources such as thermal electric generators, gas generators, wind generators, or other suitable power sources that are configured to output a DC power. Alternatively, or in addition, the system 300 can be connected to a utility grid or other AC power source. A rectifier can be used to convert the AC power from the utility grid or other AC power source to DC power prior to charging the battery 328. The solar panel 329 has been omitted from FIGS. 4-13 to simplify the figures, but it is understood that the solar panel 329, or other DC or AC power source, can be connected to the battery 328 to provide a charge to the battery in any of the configurations discussed in relation to FIGS. 4-13.

As will be appreciated by one of skill in the art, batteries are generally required to operate within a predetermined temperature range. For example, the ideal operating temperature for some batteries is between 50° F. and 85° F. with an optimal temperature of 77° F. When batteries are operated outside of this temperature range, the batteries begin to exhibit degraded performance, are unable to hold a charge, and may eventually become damaged. To ensure the battery 328 is maintained within a predetermined temperature range (e.g., the target or ideal operational temperature range for a given battery), the battery-integrated heat pump system 300 can be configured to circulate a fluid through, along, around, or otherwise brought into thermal communication with the battery 328 to control a temperature of the battery 328. As will become apparent throughout this disclosure, the disclosed technology can include multiple components and configurations capable of heating or cooling the battery 328 as required.

To help control a temperature of the battery 328, the battery-integrated heat pump system 300 can include one or more control valves 320a, 320b, and 320c that can be configured to control a flow of the refrigerant. At least one of the control valves 320a, 320b, and/or 320c can control a flow of the refrigerant through an auxiliary expansion and check valve assembly 310 and an auxiliary heat exchanger coil 322. The control valves 320a, 320b, and 320c can be any type of valve configured to control a flow of refrigerant. The control valves 320a, 320b, and 320c, for example and not limitation, can be a ball valve, a plug valve, a butterfly valve, a gate valve, a globe valve, a needle valve, a coaxial valve, an angle seat valve, a three-way valve, or any other type of valve that would be suitable for the particular application. The control valves 320a, 320b, and 320c can each be the same type of valve, or the control valves 320a, 320b, and 320c can be different types of valves depending on the particular configuration. Furthermore, the control valves 320a, 320b, and 320c can be configured to be controlled by any suitable method, including manually controlled, electronically controlled, pneumatically controlled, and/or hydraulically controlled. The auxiliary expansion and check valve assembly 310 can be or include the same type of expansion valve and check valve previously described in relation to the expansion and check valve assembly 110. The auxiliary heat exchanger coil 322 can be configured to transfer heat between the refrigerant and a fluid that is circulated to the battery 328 by a pump 324. The pump 324 can be connected to the auxiliary heat exchanger coil 322 and the battery 328 by piping 326. The fluid can be any suitable type of fluid for facilitating heating and cooling of the battery 328. The fluid, for example and not limitation, can be or include water, air, glycol, dielectric fluid, or any other suitable fluid for the particular application.

Because the auxiliary heat exchanger coil 322 can be configured to transfer heat between the refrigerant and the fluid, the auxiliary heat exchanger coil 322 can facilitate heating or cooling of the battery 328. To illustrate, when the battery-integrated heat pump system 300 is in a cooling mode, as depicted in FIG. 3, the control valve 320a can be opened to allow some or all of the refrigerant to flow through the auxiliary expansion and check valve assembly 310 and an auxiliary heat exchanger coil 322. By flowing through the expansion valve of the auxiliary expansion and check valve assembly 310, the refrigerant can begin to expand prior to entering the auxiliary heat exchanger coil 322 and complete the expansion process as the refrigerant passes through the auxiliary heat exchanger coil 322. Thus, the auxiliary heat exchanger coil 322 can be an evaporator that can remove heat from the liquid that is circulated to the battery 328 and through the auxiliary heat exchanger coil 322. In this way, when the battery-integrated heat pump system 300 is in a cooling mode and the battery 328 requires cooling (e.g., when the temperature of the battery 328 is greater than a high temperature threshold), the control valve 320a can be opened to cause refrigerant to flow through the auxiliary heat exchanger coil 322 and remove heat from the fluid to facilitate cooling of the battery 328. This configuration, for example, can be advantageous in high ambient temperatures when the battery 328 would require cooling to ensure the temperature of the battery 328 is maintained within the predetermined temperature range.

When the temperature of the battery 328 is less than a low temperature threshold, the battery-integrated heat pump system 300 can be configured to provide heating to the battery 328. As depicted in FIG. 4, the flow of refrigerant through the auxiliary heat exchanger coil 322 can be reversed when the battery-integrated heat pump system 300 is in a heating mode to cause the auxiliary heat exchanger coil 322 to act as a condenser. As will be appreciated by one of skill in the art, by operating as a condenser, the auxiliary heat exchanger coil 322 can facilitate heat transfer to the fluid flowing to the battery 328 and the auxiliary heat exchanger coil 322. By facilitating heat transfer to the fluid flowing to the battery 328, the auxiliary heat exchanger coil 322 can cause the fluid to be heated to provide heat to the battery 328. This configuration, for example, can be advantageous in low ambient temperatures when the battery 328 might require heating to ensure the temperature of the battery 328 is maintained within the predetermined temperature range.

To help control the flow of refrigerant through the auxiliary heat exchanger coil 322, the battery-integrated heat pump system 300 can include a second control valve 320c that can be in addition to, or in place of, the control valve 320a. As depicted in FIG. 4, the second control valve 320c can be located in a fluid path between the reversing valve 104 and the auxiliary heat exchanger coil 322. In this way, the second control valve 320c can be used to control the flow of refrigerant leaving the reversing valve 104. The second control valve 320c can be the same type, or a different type, of valve as the control valve 320a.

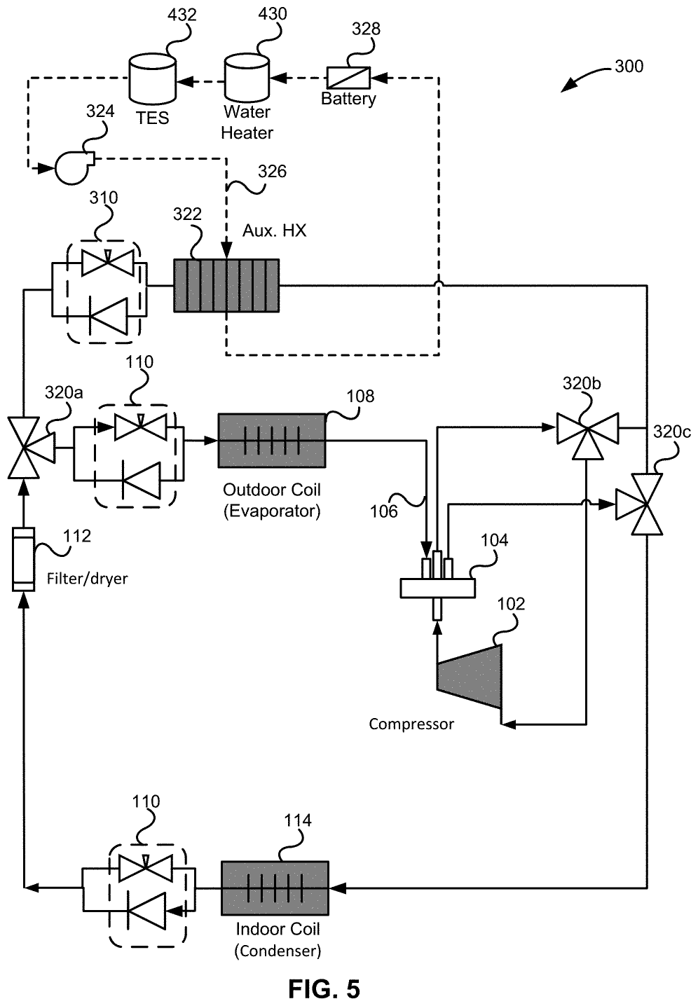

The battery-integrated heat pump system 300 can include a water heater 430 and a thermal energy storage system (TES) 432 to help control the temperature of the battery 328. The water heater 430 can be connected to the piping 326 to be in fluid communication with the battery 328. Although depicted in FIG. 4 and other figures as being located in a fluid flow path upstream of the battery 328, the water heater 430 and/or the TES 432 can be located downstream of the battery 328 as depicted in FIG. 5 and other figures. As will be appreciated by one of skill in the art, the direction of the fluid circulated through the battery 328, the water heater 430, and the TES 432 can be reversed depending on the particular configuration and a given mode of operation. For example, the pump 324 can be configured to reverse a direction of the fluid depending on whether the fluid circulated through the battery 328 should heat or cool the battery 328. Similarly, the system 300 can include a reversing valve (similar to reversing valve 104) that can be configured to redirect the flow of the fluid through the battery 328, the water heater 430, and the TES 432 in different orders depending on the whether the fluid circulated through the battery 328 should heat or cool the battery 328.

The water heater 430 can be a conventional water heater, or the water heater can be any type of heater configured to heat the fluid. For example, if the fluid is water, the water heater 430 can be a conventional water heater (or a preheating tank in fluid communication with a conventional water heater system) that is capable of heating the water circulated to the battery as well as providing heated water to a home or building. If the fluid is some fluid other than water, the water heater 430 can be a resistive heating element, a gas-fired fluid heater, or any other type of heating device configured to add heat to the fluid being circulated to the battery 328. As will be appreciated by one of skill in the art, the water heater 430 can be activated to raise the temperature of the fluid to provide further heating to the battery 328. For example, as depicted in FIG. 4, if the fluid is being heated by the auxiliary heat exchanger coil 322 but the temperature of the fluid is not rising quickly enough or is unable to reach a suitably high temperature, the water heater 430 can be activated to further raise the temperature of the fluid and heat the battery 328. Furthermore, as depicted in FIG. 5, the water heater 430 can be used to heat the battery 328 when the auxiliary heat exchanger coil 322 is not being operated to heat the water (as illustrated by the grayed-out components in FIG. 5). Thus, the water heater 430 can heat the battery 328 independent of the auxiliary heat exchanger coil 322. Stated otherwise, the heat pump system 300 can be configured to provide heat to the battery 328 in conjunction with providing heat to the indoor space, or the heat pump system 300 can be configured to provide heat to the battery 328 separate from providing heat to the indoor space.

The TES 432 can be any type of thermal energy storage system suitable for the application. The TES 432, for example and not limitation, can be a sensible heat storage system, a latent heat storage system, a thermo-chemical energy storage system, or any other type of thermal energy storage system suitable for the application. The TES 432 can be used to store thermal energy and release the thermal energy when required to help control the temperature of the battery 328. For example, the TES 432 can store heat energy when the fluid is heated but the battery 328 does not require all of the heat energy of the fluid to be kept within the predetermined temperature range. When the battery 328 requires additional heat energy (e.g., when the water heater 430 or the auxiliary heat exchanger coil 322 are no longer heating the fluid or are unable to provide sufficient heat to the battery 328) the TES 432 can release the stored heat energy to heat the battery 328. Conversely, the TES 432 can be configured to cool the battery when the auxiliary heat exchanger coil 322 is not operating or is otherwise unable to sufficiently cool the fluid to cool the battery 328. As will be appreciated by one of skill in the art, the TES 432 can reduce wide temperature variations of the fluid and the battery 328 and help to maintain the battery 328 within the predetermined temperature range.

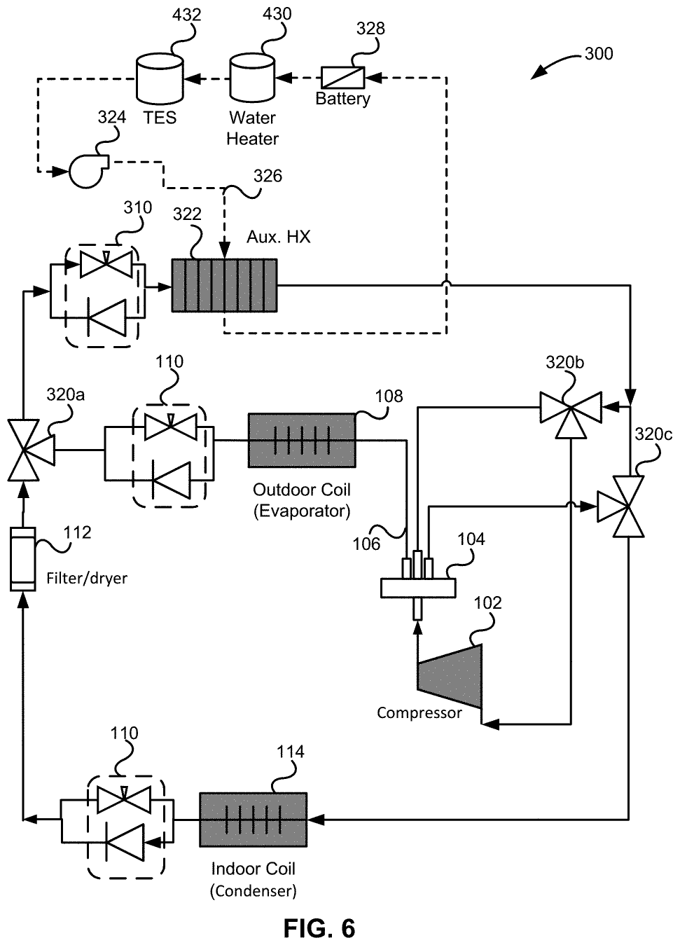

In low outdoor ambient temperature conditions, the battery-integrated heat pump system 300 can be configured to heat the home or building more efficiently by bypassing the outdoor coil 108 altogether as illustrated in FIG. 6. For example, when the system 300 is operating in a heating mode and the outdoor ambient temperature is less than a low temperature threshold, the control valve 320a and the second control valve 320c can cause the refrigerant to bypass the outdoor coil 108 and pass only through the auxiliary heat exchanger coil 322 as long as the battery 328 temperature is greater than or equal to a low temperature threshold. Because the battery 328 generates heat when it is discharging energy to operate the system 300, the battery 328 will heat the fluid and the heated fluid can pass through the auxiliary heat exchanger coil 322. By causing the refrigerant to pass through the auxiliary heat exchanger coil 322, the refrigerant will receive heat energy from the fluid and release the heat energy to the indoor air at the indoor coil 114. In this way, the waste heat of the battery can be used to cause the system 300 to operate more efficiently than the system 300 would otherwise be capable of operating in low ambient outdoor temperatures.

If additional heating is necessary, the system 300 can activate the water heater 430 to heat the fluid. The additional heat added to the fluid by the water heater 430 can be transferred to the refrigerant through the auxiliary heat exchanger coil 322 to provide further heating the building. Furthermore, if the system 300 includes the TES 432, any stored heat energy can be released to the fluid to provide further heating of the fluid and, consequently, the building. As will be appreciated by one of skill in the art, the temperature of the battery 328 can be continuously monitored to ensure that the battery 328 does not fall below a low temperature threshold while heat is being removed from the fluid to the refrigerant.

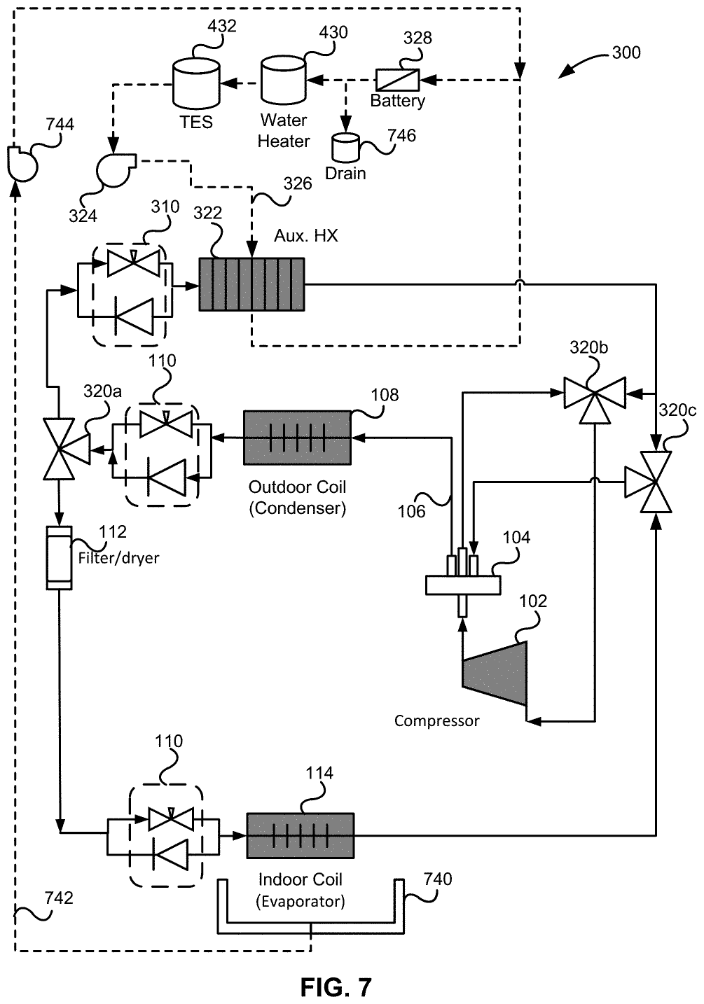

As illustrated in FIG. 7, the battery-integrated heat pump system 300 can be configured to provide cooling to the battery 328 by collecting condensate from the indoor coil when the system 300 is in a cooling mode. The system 300 can include a condensate collector 740, tubing 742, and a condensate pump 744 to direct collected condensate from the indoor coil 114 to the battery 328. As will be appreciated by one of skill in the art, condensate that accumulates at the indoor coil 114 is typically collected and simply drained from the system 300 altogether. This condensate typically is at a temperature of about 60° F. and can be passed to the battery 328 to cool the battery 328 to help maintain the temperature of the battery 328 within the predetermined temperature range. To illustrate, if the temperature of the battery 328 is greater than a high temperature threshold, the condensate pump 744 can be activated to direct the cool condensate from the indoor coil 114 to the battery 328 to cool the battery 328. After the condensate has passed to the battery 328, the condensate can either be drained from the system 300 through a drain 746, or the condensate can be added to the water heater 430 and used for other purposes (e.g., providing heated water to the building).

As will be appreciated by one of skill in the art, the temperature of the battery 328 can be maintained within the predetermined temperature range by utilizing any of the above-described components, either alone or in combination, to heat or cool the battery 328. As a non-limiting example, the condensate pump 744 and the water heater 430 can be operated simultaneously to ensure the temperature of the fluid delivered to the battery 328 is kept within a predetermined temperature range.

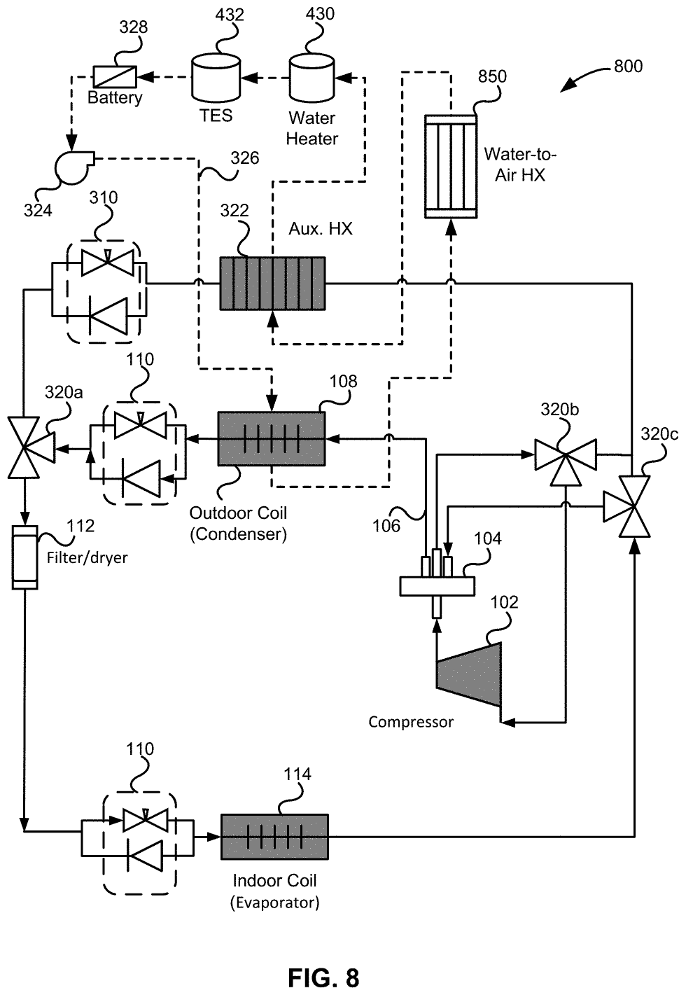

As illustrated in FIG. 8, the disclosed technology can include a battery-integrated heat pump system 800 that can be configured to route the fluid through both the outdoor coil 108 and the auxiliary heat exchanger coil 322. The system 800 can include a water-to-air heat exchanger 850 that can facilitate heat transfer between the fluid and the ambient air. For example, the water- to-air heat exchanger 850 can be configured to cool the fluid by transferring heat from the fluid to the ambient air.

When the system 800 is in a cooling mode, the refrigerant passed through the outdoor coil 108 can reject heat to the fluid that is to be passed through the outdoor coil 108. The heat transferred to the fluid can then be rejected to the ambient air through the water-to-air heat exchanger 850. If the battery 328 requires cooling, the fluid can then be passed to the battery 328 to facilitate cooling of the battery 328. The system 800 can include the water heater 430 and the TES 432 previously described. As previously described, the water heater 430 can be used to provide heat to the battery 328, and/or the TES 432 can be used to heat or cool the battery depending on the particular configuration.

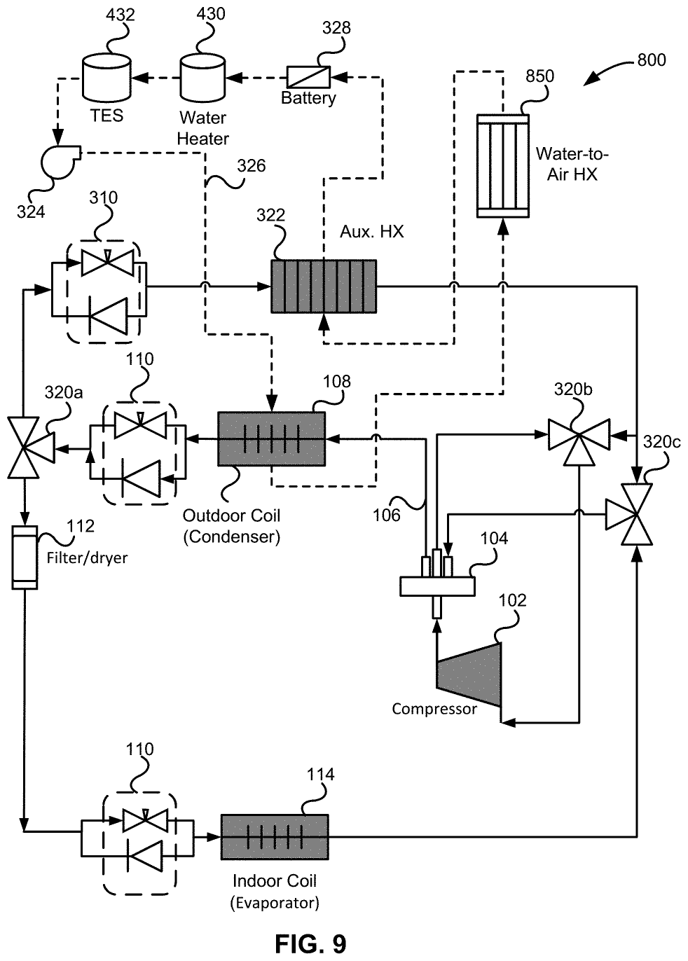

As will be appreciated by one of skill in the art, in the configuration illustrated in FIG. 8, the battery 328 may heat the fluid passed to it to the point where the refrigerant is unable to efficiently reject heat to the fluid. In this situation, the system 800 can actuate the control valve 320a and or the second control valve 320c to cause refrigerant to pass through the auxiliary heat exchanger coil 322 to cool the fluid. For example, as illustrated in FIG. 9, the system 800 can be configured to provide both space cooling and battery 328 cooling. To illustrate, if the fluid temperature is greater than a high temperature threshold, the control valve 320a and/or the second control valve 320c can be activated to cause the refrigerant to pass through the auxiliary heat exchanger coil 322 to cause the auxiliary heat exchanger coil 322 to cool the fluid. Thus, the heat rejected to the fluid can be released to the ambient air at the water-to-air heat exchanger 850 and to the refrigerant through the auxiliary heat exchanger coil 322. The fluid can then be passed to the battery 328 to cool the battery 328.

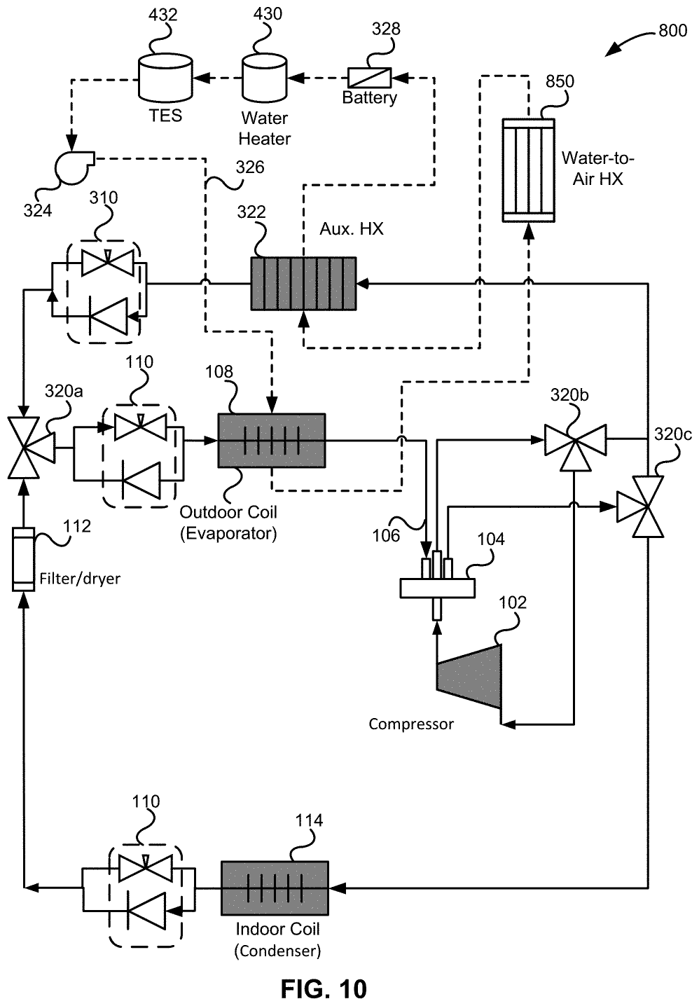

As illustrated in FIG. 10, when the system 800 is operating in a heating mode, heat from the fluid can be rejected to the refrigerant passing through the outdoor coil 108 to transfer the heat energy to the indoor air and heat the building. If the ambient air temperature is greater than the temperature of the fluid, the fluid can be circulated through the water-to-air heat exchanger 850 to absorb heat from the ambient air. Alternatively, if the ambient air temperature is less than the temperature of the fluid, the fluid can bypass the water-to-air heat exchanger 850 to prevent heat loss to the ambient air. In either configuration, if the battery 328 requires heating, the fluid can be passed through the auxiliary heat exchanger coil 322 to absorb heat rejected to the fluid from the refrigerant to provide heat to the battery 328. If the battery 328 requires further heating, the water heater 430 can be activated to further heat the fluid. Furthermore, if the system 800 includes the TES 432, the heat energy stored in the TES 432 can be released to the fluid to heat the battery 328.

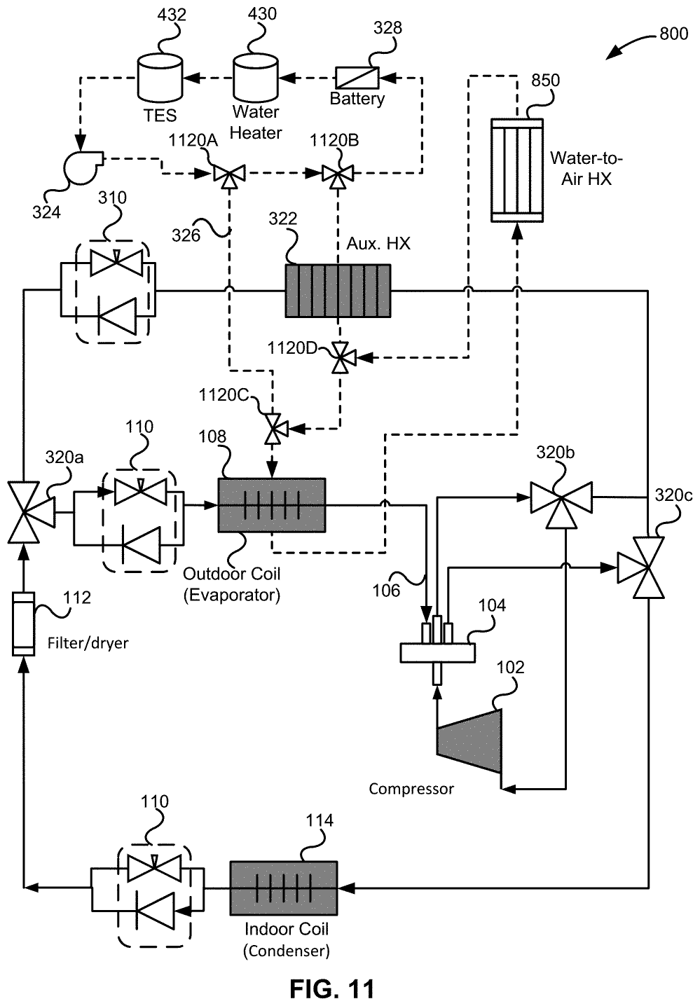

As illustrated in FIG. 11, the system 800 can be configured to facilitate space heating by using the water-to-air heat exchanger 850. The system 800 can include valves 1120A-D that can isolate fluid paths of the fluid to create two separate fluid loops. Just as the control valve 320a, the valves 1120A-D can be any suitable type of valve for the application. One fluid loop can be used to heat the battery 328 with only the water heater 430 and/or the TES 432. In the second fluid loop, fluid can be passed through just the outdoor coil 108 and the water-to-air heat exchanger 850 to transfer heat between the ambient air and the refrigerant to heat the building. In this way, the system 800 can continue to heat the building while only adding heat to the battery 328 when the temperature of the battery 328 is less than a low temperature threshold.

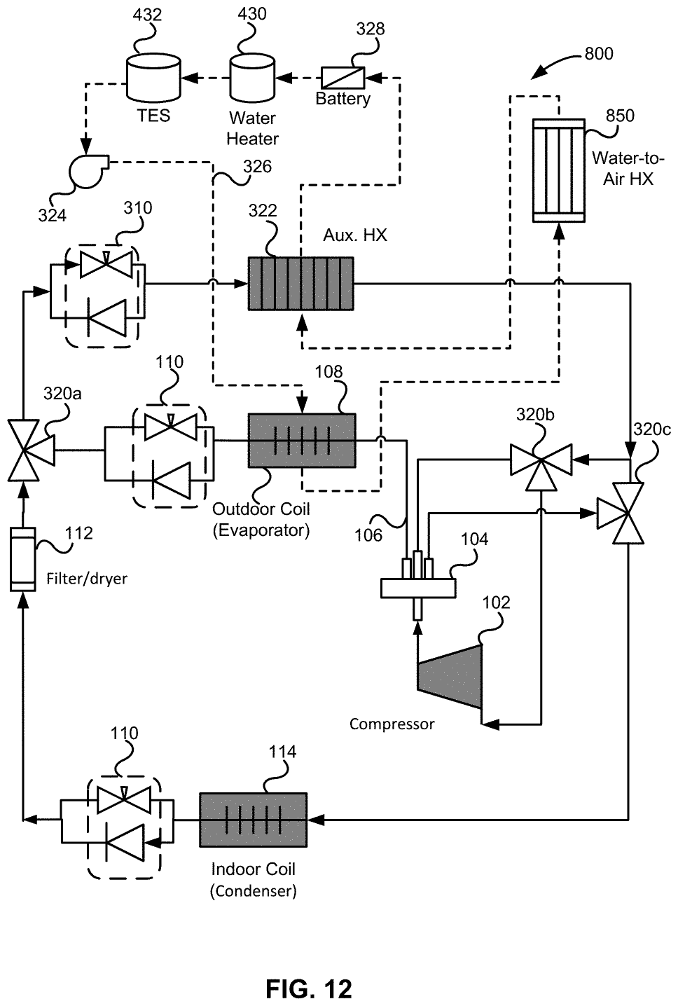

As before, in low outdoor ambient temperature conditions, the system 800 can be configured to heat the home or building more efficiently by bypassing the outdoor coil 108 altogether as illustrated in FIG. 12. For example, when the system 800 is operating in a heating mode and the outdoor ambient temperature is less than a low temperature threshold, the control valve 320a and the second control valve 320c can cause the refrigerant to bypass the outdoor coil 108 and pass only through the auxiliary heat exchanger coil 322 as long as the temperature of the battery 328 is greater than a low threshold temperature of the battery 328. Because the battery 328 generates heat when it is discharging energy to operate the system 300, the battery 328 will heat the fluid and the heated fluid can pass through the auxiliary heat exchanger coil 322. By causing the refrigerant to pass through the auxiliary heat exchanger coil 322, the refrigerant will receive heat energy from the fluid and release the heat energy to the indoor air at the indoor coil 114. In this way, the waste heat of the battery can be used to cause the system 300 to operate more efficiently than the system 300 would otherwise be capable of operating in low ambient outdoor temperatures.

If additional heating is necessary, the system 800 can activate the water heater 430 to heat the fluid and cause the fluid to bypass the water-to-air heat exchanger 850. The additional heat added to the fluid by the water heater 430 can be transferred to the refrigerant through the auxiliary heat exchanger coil 322 to provide further heating the building. Furthermore, if the system 800 includes the TES 432, any stored heat energy can be released to the fluid to provide further heating of the fluid and, consequently, the building. As will be appreciated by one of skill in the art, the temperature of the battery 328 can be continuously monitored to ensure that the battery 328 does not fall below a low temperature threshold while heat is being removed from the fluid to the refrigerant.

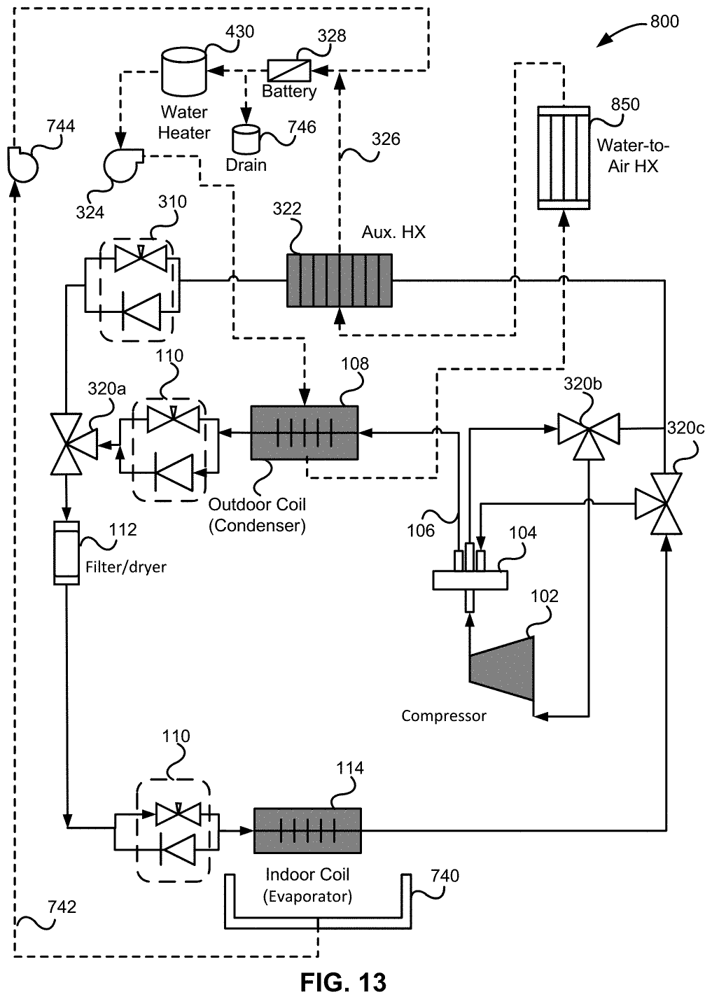

As illustrated in FIG. 13, the battery-integrated heat pump system 800 can be configured to provide cooling to the battery 328 by collecting condensate from the indoor coil when the system 800 is in a cooling mode. As before, the system 800 can include a condensate collector 740, tubing 742, and a condensate pump 744 to direct collected condensate from the indoor coil 114 to the battery 328. As will be appreciated by one of skill in the art, condensate that accumulates at the indoor coil 114 is typically collected and simply drained from the system 800 altogether. This condensate typically is at a temperature of about 60° F. and can be passed to the battery 328 to help maintain the temperature of the battery 328 within the predetermined temperature range. To illustrate, if the temperature of the battery 328 is greater than a battery high temperature threshold, the condensate pump 744 can be activated to direct the cool condensate from the indoor coil 114 to the battery 328 to cool the battery 328. After the condensate has passed to the battery 328, the condensate can either be drained from the system 800 through a drain 746, or the condensate can be added to the water heater 430 and used for other purposes (e.g., providing heated water to the building).

As will be appreciated by one of skill in the art, the temperature of the battery 328 can be maintained within the predetermined temperature range by utilizing any of the above-described components, either alone or in combination, to heat or cool the battery 328. As a non-limiting example, the condensate pump 744 and the water heater 430 can be operated simultaneously to ensure the temperature of the fluid delivered to the battery 328 is kept within a predetermined temperature range.

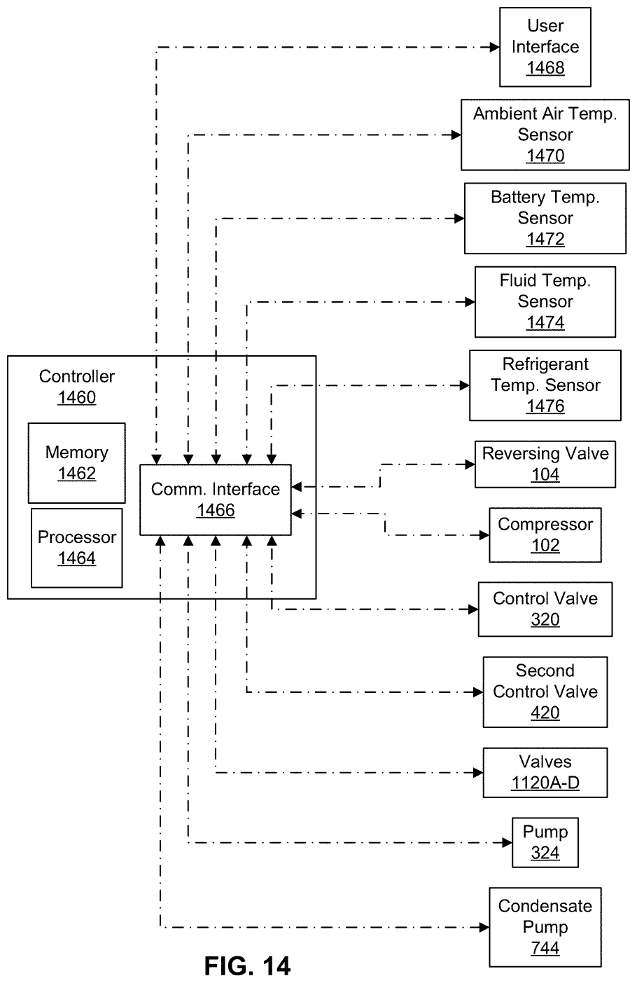

As depicted in FIG. 14, the disclosed technology can include a controller 1460 that can be configured to receive data and determine actions based on the received data. For example, the controller 1460 can be configured to monitor the temperature of the battery 328 and output control signals to the various components described herein to either provide heating or cooling to the battery 328. The controller 1460 can receive data from, or output data to, the user interface 1468, the ambient air temperature sensor 1470, the battery temperature sensor 1472, the fluid temperature sensor 1474, the refrigerant temperature sensor 1476, the compressor 102, the reversing valve 104, the control valve 320a, the second control valve 320c, the valves 1120A-D, the pump 324, and the condensate pump 744.

The ambient air temperature sensor 1470 can be configured to detect a temperature of the ambient air proximate the battery 328. The battery temperature sensor 1472 can be configured to detect a temperature of the battery 328. The fluid temperature sensor 1474 can be configured to detect a temperature of the fluid that is circulated to the battery. The refrigerant temperature sensor can be configured to detect a temperature of the refrigerant. Each of the temperature sensors can be any type of temperature sensor including a thermocouple, a resistance temperature detector, a thermistor, a semiconductor based integrated circuit, or any other suitable type of temperature sensor for the particular application.

The controller 1460 can have a memory 1462, a processor 1464, and a communication interface 1466. The controller 1460 can be a computing device configured to receive data, determine actions based on the received data, and output a control signal instructing one or more components of the system 300, or system 800, to perform one or more actions. One of skill in the art will appreciate that the controller 1460 can be installed in any location, provided the controller 1460 is in communication with at least some of the components of the system. Furthermore, the controller 1460 can be configured to send and receive wireless or wired signals and the signals can be analog or digital signals. The wireless signals can include Bluetooth™, BLE, WiFi™ZigBee™, infrared, microwave radio, or any other type of wireless communication as may be suitable for the particular application. The hard-wired signal can include any directly wired connection between the controller and the other components described herein. Alternatively, the components can be powered directly from a power source and receive control instructions from the controller 1460 via a digital connection. The digital connection can include a connection such as an Ethernet or a serial connection and can utilize any suitable communication protocol for the application such as Modbus, fieldbus, PROFIBUS, SafetyBus p, Ethernet/IP, or any other suitable communication protocol for the application. Furthermore, the controller 1460 can utilize a combination of wireless, hard-wired, and analog or digital communication signals to communicate with and control the various components. One of skill in the art will appreciate that the above configurations are given merely as non-limiting examples and the actual configuration can vary depending on the particular application.

The controller 1460 can include a memory 1462 that can store a program and/or instructions associated with the functions and methods described herein and can include one or more processors 1464 configured to execute the program and/or instructions. The memory 1462 can include one or more suitable types of memory (e.g., volatile or non-volatile memory, random access memory (RAM), read only memory (ROM), programmable read-only memory (PROM), erasable programmable read-only memory (EPROM), electrically erasable programmable read- only memory (EEPROM), magnetic disks, optical disks, floppy disks, hard disks, removable cartridges, flash memory, a redundant array of independent disks (RAID), and the like) for storing files including the operating system, application programs (including, for example, a web browser application, a widget or gadget engine, and or other applications, as necessary), executable instructions and data. One, some, or all of the processing techniques or methods described herein can be implemented as a combination of executable instructions and data within the memory.

The controller 1460 can also have a communication interface 1466 for sending and receiving communication signals between the various components. Communication interface 1466 can include hardware, firmware, and/or software that allows the processor(s) 1464 to communicate with the other components via wired or wireless networks, whether local or wide area, private or public, as known in the art. Communication interface 1466 can also provide access to a cellular network, the Internet, a local area network, or another wide-area network as suitable for the particular application.

Additionally, the controller 1460 can have or be in communication with a user interface 1468 for displaying system information and receiving inputs from a user. The user interface 1468 can be installed locally or be a remotely controlled device such as a mobile device. The user, for example, can view system data on the user interface 1468 and input data or commands to the controller 1460 via the user interface 1468. For example, the user can view temperature threshold settings on the user interface 1468 and provide inputs to the controller 1460 via the user interface 1468 to change a temperature threshold setting.

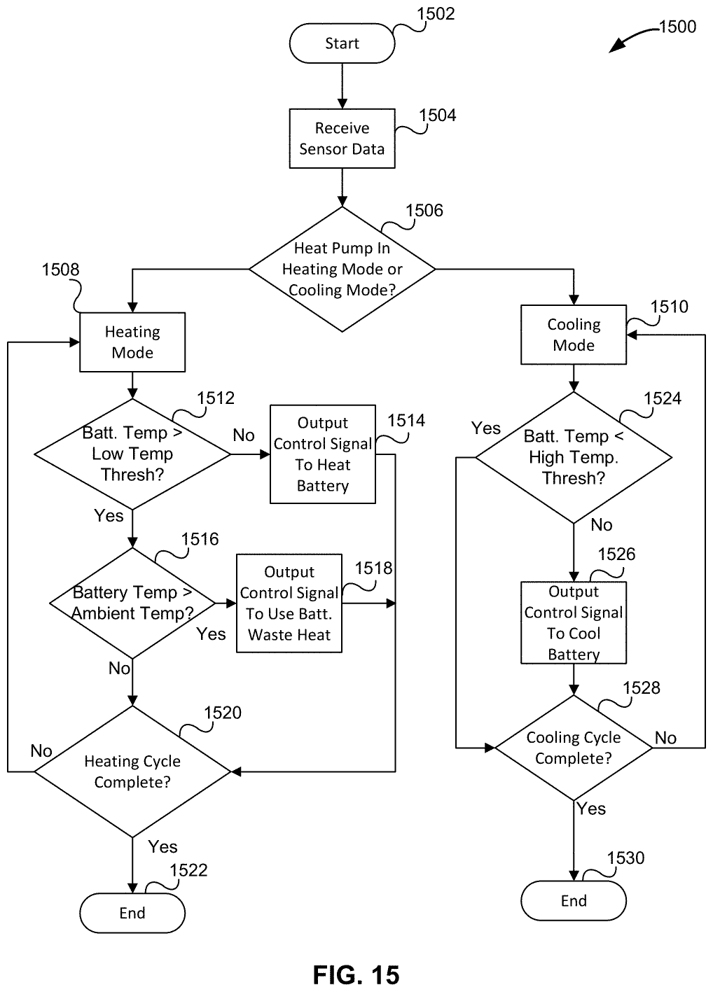

FIG. 15 illustrates a method 1500 of operating a battery-integrated heat pump system, in accordance with the disclosed technology. The method 1500 can include starting 1502 a logic sequence by receiving a start signal or by initiating the method 1500 (e.g., as power is received to the controller 1460). The method 1500 can include receiving 1504 sensor data from one or more sensors in the heat pump system (e.g., ambient temperature data from the ambient air temperature sensor 1470, battery temperature data from the battery temperature sensor 1472, fluid temperature data from the fluid temperature sensor 1474, refrigerant temperature data from the refrigerant temperature sensor 1476, or any other data from a connected sensor). The method 1500 can include determining 1506 whether the heat pump system is in a heating mode 1508 or a cooling mode 1510 (e.g., based on a user-inputted setting, based on a current configuration of one or more valves, based on the temperature data, based on a flow direction of the refrigerant).

If the system is in a heating mode 1508, the method 1500 can include determining 1512 whether the temperature of the battery is greater than a low battery temperature threshold. The low battery temperature threshold, for example, can be a predetermined low temperature at which point the battery will begin to exhibit degraded performance or a predetermined low temperature at which the battery can avoid short-term and/or long-term degraded performance. If the temperature of the battery is less than or equal to the low temperature threshold of the battery, the method 1500 can include outputting 1514 a control signal to begin heating the battery. Outputting 1514 a control signal to begin heating the battery can include any of the methods of heating the battery described herein above or any combinations of the methods of heating the battery described herein above. To illustrate, outputting 1514 a control signal to begin heating the battery can include outputting a control signal to the control valve 320a and/or the second control valve 320c to cause the refrigerant to pass through the auxiliary heat exchanger coil 322 to act as a condenser and begin providing heat to the fluid to heat the battery 328. As another non-limiting illustrative example, outputting 1514 a control signal to begin heating the battery can include outputting a control signal to the water heater 430 to begin heating the fluid to heat the battery 328.

If the battery temperature is greater than the low temperature threshold of the battery, the method 1500 can include determining 1516 whether the battery temperature is greater than the ambient temperature. If the battery temperature is greater than the ambient temperature, the method 1500 can include outputting 1518 a control signal to begin using the battery waste heat as the heat source for the heat pump. Outputting 1518 a control signal to begin using the battery waste heat as the heat source for the heat pump can include any of the method herein describe above. To illustrate, outputting 1518 a control signal to begin using the battery waste heat as the heat source for the heat pump can include outputting a control signal to the control valve 320a and/or the second control valve 320c to cause the refrigerant to pass through the auxiliary heat exchanger coil 322 to act as an evaporator and utilize the waste heat generated by the battery 328. As will be appreciated by one of skill in the art, and as described herein above, when the ambient temperature is greater than the battery temperature, the heat generated by the battery can be used to preheat the air delivered to the heat exchanger coil.

If the battery temperature is less than or equal to the ambient temperature, the method 1500 can include determining 1520 whether the heating cycle is completed. If the heating cycle is not completed, the method 1500 can include returning to the beginning of the heating mode 1508 and repeating the steps described above. If the heating cycle is completed, the method 1500 can end 1522 by stopping the heating cycle.

If the system is in a cooling mode 1510, the method 1500 can include determining 1524 whether the battery temperature is less than a high temperature threshold of the battery. The high temperature threshold of the battery, for example, can be a predetermined high temperature at which point the battery will begin to exhibit degraded performance. If the temperature of the battery is less than the high temperature threshold of the battery, the method 1500 can include determining 1528 whether the cooling cycle of the heat pump system is complete. If the cooling cycle is not complete, the method 1500 can include returning to the beginning of the cooling mode 1510 and once again determining 1524 whether the battery temperature is less than the high temperature threshold of the battery.

If the temperature of the battery is greater than or equal to the high temperature threshold of the battery, the method 1500 can include outputting 1526 a control signal to cool the battery. Outputting 1526 a control signal to cool the battery can include any of the methods of cooling the battery 328 described herein above or any combination of the methods of cooling the battery 328 described herein above. To illustrate, outputting 1526 a control signal to cool the battery can include outputting a control signal to the control valve 320 and/or the second control valve 320c to cause refrigerant to pass through the auxiliary heat exchanger coil 322 to cause the auxiliary heat exchanger coil 322 to act as an evaporator to cool the fluid to cool the battery 328. As another non-limiting illustrative example, outputting 1526 a control signal to cool the battery can include outputting a control signal to the condensate pump 744 to begin delivering condensate to the battery 328 to cool the battery 328.

The method 1500 can include determining 1528 whether the cooling cycle is complete. If the cooling cycle in not complete, the method 1500 can include returning to the beginning of the cooling mode 1510 and repeating the actions just described. If the cooling cycle is complete, the method 1500 can end 1530 by stopping the cooling cycle.

As will be appreciated, the method 1500 just described can be varied in accordance with the various elements and implementations described herein. That is, methods in accordance with the disclosed technology can include all or some of the steps described above and/or can include additional steps not expressly disclosed above. Further, methods in accordance with the disclosed technology can include some, but not all, of a particular step described above. Further still, various methods described herein can be combined in full or in part. That is, methods in accordance with the disclosed technology can include at least some elements or steps of a first method and at least some elements or steps of a second method.

While the present disclosure has been described in connection with a plurality of exemplary aspects, as illustrated in the various figures and discussed above, it is understood that other similar aspects can be used, or modifications and additions can be made to the described subject matter for performing the same function of the present disclosure without deviating therefrom. In this disclosure, methods and compositions were described according to aspects of the presently disclosed subject matter. But other equivalent methods or compositions to these described aspects are also contemplated by the teachings herein. Therefore, the present disclosure should not be limited to any single aspect, but rather construed in breadth and scope in accordance with the appended claims.

What is claimed is:

1. A system comprising:
an indoor heat exchanger coil in fluid communication with a refrigerant circuit;
an outdoor heat exchanger coil in fluid communication with the refrigerant circuit;
a compressor in fluid communication with the refrigerant circuit, the compressor configured to circulate a refrigerant through the refrigerant circuit,
a battery in thermal communication with a fluid circuit;
a pump in fluid communication with the fluid circuit, the pump configured to circulate a fluid through the fluid circuit; and
a third heat exchanger coil in fluid communication with the refrigerant circuit and the fluid circuit, the third heat exchanger coil being configured to facilitate heat transfer between the refrigerant and the battery via the fluid.

2. The system of claim 1, wherein the fluid is water, the system further comprising a water heater in fluid communication with the fluid circuit and configured to heat the water to facilitate heating of the battery.

3. The system of claim 1 further comprising a thermal energy storage system in fluid communication with the fluid circuit, wherein the thermal energy storage system is configured to store thermal energy transferred to the thermal energy storage system by the fluid and transfer the stored thermal energy to the fluid to facilitate heating and cooling of the battery.

4. The system of claim 1 further comprising one or more valves configured to control a first flow of the refrigerant through the outdoor heat exchanger coil and a second flow of the refrigerant through the third heat exchanger coil.

5. The system of claim 1 further comprising a condensate pump in fluid communication with the fluid circuit, wherein the condensate pump is configured to move condensate from the indoor heat exchanger coil to the battery to facilitate cooling of the battery.

6. The system of claim 1, further comprising a fourth heat exchanger in fluid communication with the fluid circuit and configured to facilitate heat transfer between the fluid and air.

7. The system of claim 6, wherein the fluid is water, the system further comprising a water heater configured to heat the water to facilitate heating of the battery.

8. The system of claim 6 further comprising a thermal energy storage system, wherein the thermal energy storage system is configured to store thermal energy transferred to the thermal energy storage system by the fluid and transfer the stored thermal energy to the fluid to facilitate heating or cooling of the battery.

9. The system of claim 1 further comprising:
a battery temperature sensor configured to detect a temperature of the battery; and
a controller configured to:
receive battery temperature data from the battery temperature sensor; and
output a control signal to the pump to circulate the fluid through the fluid circuit based at least in part on the battery temperature data.

10. The system of claim 9 further comprising a valve configured to control a flow of the refrigerant through the third heat exchanger,
wherein the controller is further configured to output a control signal to the valve to change a position of the valve to control the flow of the refrigerant through the third heat exchanger based at least in part on the battery temperature data.

11. The system of claim 9, wherein the fluid is water, the system further comprising a water heater in fluid communication with the fluid circuit and configured to heat the water to facilitate heating of the battery,
wherein the controller is further configured to output a control signal to the water heater to activate the water heater and begin heating the water based at least in part on the battery temperature data indicating that the battery temperature is less than a low temperature threshold.

12. The system of claim 9 further comprising a condensate pump in fluid communication with the fluid circuit,
wherein the controller is further configured to output a control signal to the condensate pump to move condensate from the indoor heat exchanger coil to the battery to facilitate cooling of the battery based at least in part on the battery temperature data indicating that the battery temperature is greater than or equal to a high temperature threshold.

13. The system of claim 9, further comprising a fourth heat exchanger in fluid communication with the fluid circuit and configured to facilitate heat transfer between the fluid and air.

14. The system of claim 13, further comprising a valve configured to control a flow of the refrigerant through the third heat exchanger,
wherein the controller is further configured to output a control signal to the valve to change a position of the valve to control the flow of the refrigerant through the third heat exchanger based at least in part on the battery temperature data.

15. The system of claim 13 further comprising a condensate pump in fluid communication with the fluid circuit,
wherein the controller is further configured to output a control signal to the condensate pump to move condensate from the indoor heat exchanger coil to the battery to facilitate cooling of the battery based at least in part on the battery temperature data indicating that the battery temperature is greater than or equal to a high temperature threshold.

16. The system of claim 13, wherein the fluid is water, the system further comprising a water heater in fluid communication with the fluid circuit and configured to heat the water to facilitate heating of the battery,
wherein the controller is further configured to output a control signal to the water heater to activate the water heater and begin heating the water based at least in part on the battery temperature data indicating that the battery temperature is less than a low temperature threshold.

17. A non-transitory, computer-readable medium storing instructions that, when executed by one or more processors, cause a controller associated with a heat pump system to:
receive battery temperature data from a battery temperature sensor, the battery temperature data being indicative of a battery temperature measured by the battery temperature sensor;
receive ambient air temperature data from an ambient air temperature sensor, the ambient air temperature data being indicative of an ambient air temperature measured by the ambient air temperature sensor;
in response to determining that (i) the battery temperature is greater than a battery low temperature threshold and (ii) the ambient air temperature is greater than an ambient air low temperature threshold, output a control signal to a control valve to cause refrigerant to flow in a first direction through an auxiliary heat exchanger in thermal communication with the battery to thereby effect a first heat transfer of waste heat from the battery to a fluid and a second heat transfer from the fluid to the refrigerant via the auxiliary heat exchanger.

18. The non-transitory, computer-readable medium of claim 17, wherein the instructions, when executed by the one or more processors, further cause the controller to:
in response to determining that the battery temperature is less than or equal to the battery low temperature threshold, output a control signal to the control valve to cause the refrigerant to flow in a second direction through the auxiliary heat exchanger to thereby effect a third heat transfer from the refrigerant to the fluid via the auxiliary heat exchanger and a fourth heat transfer from the fluid to the battery, the second direction being substantially opposite from the first direction.

19. The non-transitory, computer-readable medium of claim 17, wherein:
the fluid is water; and
the instructions, when executed by the one or more processors, further cause the controller to:
in response to determining that the battery temperature is less than or equal to the battery low temperature threshold, output a control signal to a water heater to provide heat to the water to thereby effect a transfer of heat from the water to the battery.

20. The non-transitory, computer-readable medium of claim 17, wherein the instructions, when executed by the one or more processors, further cause the controller to:
in response to determining that the battery temperature is greater than or equal to a battery high temperature threshold, output a control signal to the control valve to cause the refrigerant to flow in the first direction through the auxiliary heat exchanger to thereby effect a third heat transfer from the battery to the fluid and a fourth heat transfer from the fluid to the refrigerant via the auxiliary heat exchanger to cool the battery.
